(19) United States
(12) Patent Application Publication
(10) Pub. No.: US 2022/0076250 A1
(43) Pub. Date: Mar. 10, 2022

(54) BLOCKCHAIN ENABLED SMART COMPLIANCE

(71) Applicant: International Business Machines Corporation, Armonk, NY (US)

(72) Inventors: Nitin Gaur, Round Rock, TX (US); Petr Novotny, Mount Kisco, NY (US); Timothy Olson, Port Orchard, WA (US); MALAVAN BALANAVANEETHAN, Sengkang (SG)

(21) Appl. No.: 17/017,169

(22) Filed: Sep. 10, 2020

(51) Int. Cl. G06Q 20/38

(52) U.S. Cl. CPC G06Q 20/389

(57) ABSTRACT

A node in a blockchain network may receive a digital asset transfer request for a digital asset transfer, create a path object containing one or more jurisdictional requirements for the digital asset transfer request, pass the path object to a blockchain network, verify the path object, and record the path object on a blockchain network.

### BACKGROUND

The present disclosure relates generally to the field of digital asset transfer smart contracts, and more specifically to blockchain enable smart compliance.

Blockchains offer immutability of data by replicating data across all nodes of a network. In order to be able to validate the blockchain, nodes must have access to the complete history of transactions, which any data on the chain is visible for all participants.

The movement of digital assets or crypto assets is governed by smart contracts or some sort of business rules encoded in smart contracts and/or chain code between two parties or business entities. These smart contracts act as glue to ensure all conditions are met when the asset is transferred. Smart contracts also provide governance layers to ensure all conditions are met and the liabilities and responsibilities of the systems are enforced to facilitate a digital transaction system.

### SUMMARY

Embodiments of the present disclosure include a method, system, and computer program product for blockchain enabled smart compliance. Some embodiments of the present disclosure can be illustrated by a method comprising receiving, by a path object builder node, a digital asset transfer request for a digital asset transfer, creating, by the path object builder node, a path object containing one or more jurisdictional requirements for the digital asset transfer request, passing, by the path object builder node, the path object to a blockchain network, verifying, by one or more nodes in the blockchain network, the path object, and recording the path object on a blockchain network.

Some embodiments of the present disclosure can also be illustrated by a system comprising a memory, and a processor in communication with the memory, the processor being configured to perform operations comprising receiving a digital asset transfer request for a digital asset transfer, creating a path object containing one or more jurisdictional requirements for the digital asset transfer request, passing the path object to a blockchain network, verifying the path object, and recording the path object on a blockchain network.

Some embodiments of the present disclosure can also be illustrated by a computer program product comprising a computer readable storage medium having program instructions embodied therewith, the program instructions executable by a computer to cause the computer to receive a digital asset transfer request for a digital asset transfer, create a path object containing one or more jurisdictional requirements for the digital asset transfer request, pass the path object to a blockchain network, verify, by one or more nodes in the blockchain network, the path object, and record the path object on a blockchain network.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a flow diagram of blockchain enabled smart compliance, according to example embodiments.

FIG. 2 illustrates a flow diagram of creating a path object, according to example embodiments.

FIG. 3 illustrates a network diagram of a system including a database, according to an example embodiment.

FIG. 4A illustrates an example blockchain architecture configuration, according to example embodiments.

FIG. 4B illustrates a blockchain transactional flow, according to example embodiments.

FIG. 5A illustrates a permissioned network, according to example embodiments.

FIG. 5B illustrates another permissioned network, according to example embodiments.

FIG. 5C illustrates a permissionless network, according to example embodiments.

FIG. 6A illustrates a process for a new block being added to a distributed ledger, according to example embodiments.

FIG. 6B illustrates contents of a new data block, according to example embodiments.

FIG. 6C illustrates a blockchain for digital content, according to example embodiments.

FIG. 6D illustrates a block which may represent the structure of blocks in the blockchain, according to example embodiments.

FIG. 7 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

Aspects of the present disclosure relate generally to the field of due diligence for digital asset transfers in multiple jurisdictions, and more specifically to blockchain enabled model smart compliance.

It will be readily understood that the instant components, as generally described and illustrated in the figures herein, may be arranged and designed in a wide variety of different configurations. Accordingly, the following detailed description of the embodiments of at least one of a method, apparatus, non-transitory computer readable medium and system, as represented in the attached figures, is not intended to limit the scope of the application as claimed but is merely representative of selected embodiments.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Accordingly, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the FIGS., any connection between elements can permit one-way and/or two-way communication even if the depicted connection is a one-way or two-way arrow. Also, any device depicted in the drawings can be a different device. For example, if a mobile device is shown sending information, a wired device may also be used to send the information.

In addition, while the term “message” may have been used in the description of embodiments, the application may be applied to many types of networks and data. Furthermore, while certain types of connections, messages, and signaling may be depicted in exemplary embodiments, the application is not limited to a certain type of connection, message, and signaling.

Detailed herein is a method, system, and computer program product that utilize blockchain (e.g., Hyperledger Fabric) channels, and smart contracts that implement logic based on a non-interactive zero knowledge proof.

In some embodiments, the method, system, and/or computer program product utilize a decentralized database (such as a blockchain) that is a distributed storage system, which includes multiple nodes that communicate with each other. The decentralized database includes an append-only immutable data structure resembling a distributed ledger capable of maintaining records between mutually untrusted parties. The untrusted parties are referred to herein as peers or peer nodes. Each peer maintains a copy of the database records and no single peer can modify the database records without a consensus being reached among the distributed peers. For example, the peers may execute a consensus protocol to validate blockchain storage transactions, group the storage transactions into blocks, and build a hash chain over the blocks. This process forms the ledger by ordering the storage transactions, as is necessary, for consistency.

In various embodiments, a permissioned and/or a permission-less blockchain can be used. In a public or permission-less blockchain, anyone can participate without a specific identity (e.g., retaining anonymity). Public blockchains can involve native cryptocurrency and use consensus based on various protocols such as Proof of Work. On the other hand, a permissioned blockchain database provides secure interactions among a group of entities which share a common goal but which do not fully trust one another, such as businesses that exchange funds, goods, information, and the like.

Further, in some embodiments, the method, system, and/or computer program product can utilize a blockchain that operates arbitrary, programmable logic, tailored to a decentralized storage scheme and referred to as “smart contracts” or “chaincodes.” In some cases, specialized chaincodes may exist for management functions and parameters which are referred to as system chaincode. The method, system, and/or computer program product can further utilize smart contracts that are trusted distributed applications which leverage tamper-proof properties of the blockchain database and an underlying agreement between nodes, which is referred to as an endorsement or endorsement policy. Blockchain transactions associated with this application can be “endorsed” before being committed to the blockchain while transactions, which are not endorsed, are disregarded.

An endorsement policy allows chaincode to specify endorsers for a transaction in the form of a set of peer nodes that are necessary for endorsement. When a client sends the transaction to the peers specified in the endorsement policy, the transaction is executed to validate the transaction. After validation, the transactions enter an ordering phase in which a consensus protocol is used to produce an ordered sequence of endorsed transactions grouped into blocks.

In some embodiments, the method, system, and/or computer program product can utilize nodes that are the communication entities of the blockchain system. A “node” may perform a logical function in the sense that multiple nodes of different types can run on the same physical server. Nodes are grouped in trust domains and are associated with logical entities that control them in various ways. Nodes may include different types, such as a client or submitting-client node which submits a transaction-invocation to an endorser (e.g., peer), and broadcasts transaction-proposals to an ordering service (e.g., ordering node).

Another type of node is a peer node which can receive client submitted transactions, commit the transactions and maintain a state and a copy of the ledger of blockchain transactions. Peers can also have the role of an endorser, although it is not a requirement. An ordering-service-node or orderer is a node running the communication service for all nodes, and which implements a delivery guarantee, such as a broadcast to each of the peer nodes in the system when committing/confirming transactions and modifying a world state of the blockchain, which is another name for the initial blockchain transaction which normally includes control and setup information.

In some embodiments, the method, system, and/or computer program product can utilize a ledger that is a sequenced, tamper-resistant record of all state transitions of a blockchain. State transitions may result from chaincode invocations (e.g., transactions) submitted by participating parties (e.g., client nodes, ordering nodes, endorser nodes, peer nodes, etc.). Each participating party (such as a peer node) can maintain a copy of the ledger. A transaction may result in a set of asset key-value pairs being committed to the ledger as one or more operands, such as creates, updates, deletes, and the like. The ledger includes a blockchain (also referred to as a chain) which is used to store an immutable, sequenced record in blocks. The ledger also includes a state database which maintains a current state of the blockchain.

In some embodiments, the method, system, and/or computer program product described herein can utilize a chain that is a transaction log that is structured as hash-linked blocks, and each block contains a sequence of N transactions where N is equal to or greater than one. The block header includes a hash of the block's transactions, as well as a hash of the prior block's header. In this way, all transactions on the ledger may be sequenced and cryptographically linked together. Accordingly, it is not possible to tamper with the ledger data without breaking the hash links. A hash of a most recently added blockchain block represents every transaction on the chain that has come before it, making it possible to ensure that all peer nodes are in a consistent and trusted state. The chain may be stored on a peer node file system (e.g., local, attached storage, cloud, etc.), efficiently supporting the append-only nature of the blockchain workload.

The current state of the immutable ledger represents the latest values for all keys that are included in the chain transaction log. Since the current state represents the latest key values known to a channel, it is sometimes referred to as a world state. Chaincode invocations execute transactions against the current state data of the ledger. To make these chaincode interactions efficient, the latest values of the keys may be stored in a state database. The state database may be simply an indexed view into the chain's transaction log, it can therefore be regenerated from the chain at any time. The state database may automatically be recovered (or generated if needed) upon peer node startup, and before transactions are accepted.

Some benefits of the instant solutions described and depicted herein include a method, system, and computer program product for blockchain enabled model smart compliance. The exemplary embodiments solve the issues of reliability, time, and trust by extending features of a database such as immutability, digital signatures, and being a single source of truth. The exemplary embodiments provide a solution for accounting for regulations in multiple jurisdictions. The blockchain networks may be homogenous based on the asset type and rules that govern the assets based on the smart contracts.

Blockchain is different from a traditional database in that blockchain is not a central storage, but rather a decentralized, immutable, and secure storage, where nodes may share in changes to records in the storage. Some properties that are inherent in blockchain and which help implement the blockchain include, but are not limited to, an immutable ledger, smart contracts, security, privacy, decentralization, consensus, endorsement, accessibility, and the like, which are further described herein. According to various aspects, the system described herein is implemented due to immutable accountability, security, privacy, permitted decentralization, availability of smart contracts, endorsements and accessibility that are inherent and unique to blockchain.

In particular, the blockchain ledger data is immutable and that provides for an efficient method for smart compliance. Also, use of the encryption in the blockchain provides security and builds trust. The smart contract manages the state of the asset to complete the life-cycle, thus specialized path object builder nodes may ensure that an asset transfer comports with compliance requirements. The example blockchains are permission decentralized. Thus, each end user may have its own ledger copy to access. Multiple organizations (and peers) may be on-boarded on the blockchain network. The key organizations may serve as endorsing peers to validate the smart contract execution results, read-set and write-set. In other words, the blockchain inherent features provide for efficient implementation of processing a private transaction in a blockchain network.

One of the benefits of the example embodiments is that it improves the functionality of a computing system by implementing a method for processing a private transaction in a blockchain network. Through the blockchain system described herein, a computing system (or a processor in the computing system) can perform functionality for private transaction processing utilizing blockchain networks by providing access to capabilities such as distributed ledger, peers, encryption technologies, MSP, event handling, etc. Also, the blockchain enables to create a business network and make any users or organizations to on-board for participation. As such, the blockchain is not just a database. The blockchain comes with capabilities to create a network of users and on-board/off-board organizations to collaborate and execute service processes in the form of smart contracts.

The example embodiments provide numerous benefits over a traditional database. For example, through the blockchain the embodiments provide for immutable accountability, security, privacy, permitted decentralization, availability of smart contracts, endorsements and accessibility that are inherent and unique to the blockchain.

Meanwhile, a traditional database may not be useful to implement the example embodiments because a traditional database does not bring all parties on the network, a traditional database does not create trusted collaboration, and a traditional database does not provide for an efficient storage of digital assets. The traditional database does not provide for a tamper proof storage and does not provide for preservation of the due diligence of digital assets being transferred. Accordingly, the example embodiments provide for a specific solution to a problem in the arts/field of smart compliance for asset transactions.

The movement of digital assets or crypto assets may be governed by smart contracts, business rules encoded in smart contracts, and/or chain code between two parties (e.g., business entities). Smart contracts may be used to ensure all conditions are met when the asset is transferred. Smart contracts also provide governance layers to ensure all compliance requirements are met and responsibilities of the systems are fulfilled.

When digital assets or crypto assets are moved between two distinct jurisdictions, the conditions of the asset movement should satisfy both jurisdictions (the sending and receiving jurisdictions) in order to adhere to compliance requirements especially in a permissioned and regulated blockchain network. While the network itself is a digital network and transaction system, the non-digital elements (such as a business location, entity registration, and legal entity identifiers) play a crucial role in determining the jurisdiction of the entities that may have a digital representation. It is a daunting task for each organization to ensure that they are meeting the due diligence requirements for each participant and each jurisdiction of an asset transfer. Due diligence requirements may depend on existing legal doctrine and how legal, political and commercial institutions decide to treat the technology.

In some embodiments, a blockchain enables a system to ensure the compliance and regulatory adherence of a digital asset movement is provided. This system may also provide a method of recording the due diligence steps in an immutable blockchain ledger.

In some instances, a jurisdiction is the authority of a governing body to regulate, tax, and govern specific actions occurring in a particular region. Jurisdictions may determine how an asset transfer is completed. In some instances, a jurisdiction is a region in which a government body has the authority to regulate, tax, and govern specific actions that occur in the region. In some instances, multiple jurisdictions may be involved in the completion of an asset transfer. For example, an asset transfer between a first party in the United States of America (US), a second party in Germany, and a third party in Canada, may require that the asset transfer comply with laws of all three countries.

In some embodiments, a path object builder is a computer node that may determine a path for a movement of digital assets and encapsulate jurisdictional compliance by identifying smart contract invocation logic for all jurisdictions. In regard to some embodiments, the path for the movement of digital assets is the jurisdictions that the asset may have to transfer through. For example, if a company in the US sends cryptocurrency to a company in Germany through a Bank in Switzerland, the path may include the US, Germany, and Switzerland. As described herein, smart contracts are digital contracts that may have one or more specific requirements for the completion of the smart contract. In some instances, a smart contract is a computer protocol intended to digitally facilitate, verify, or enforce the negotiation or performance of a contract.

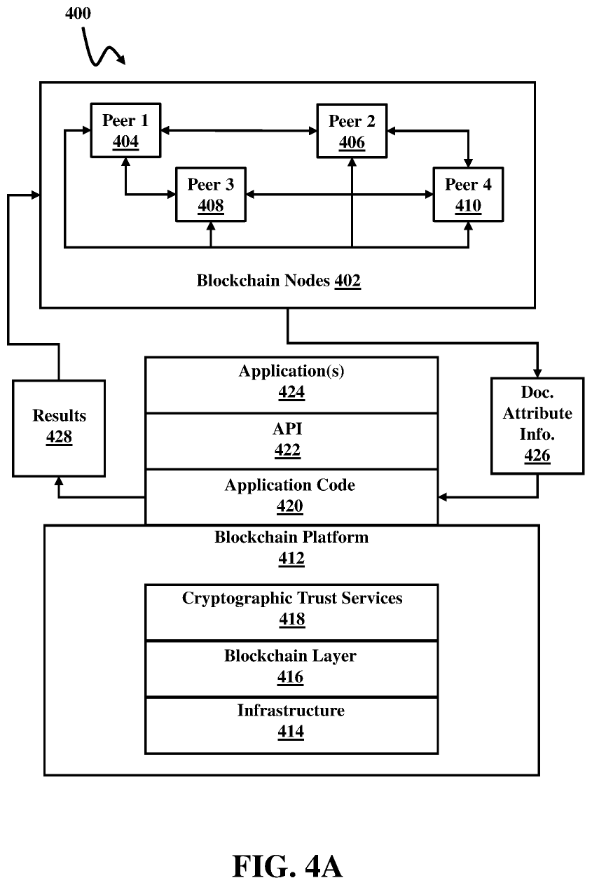

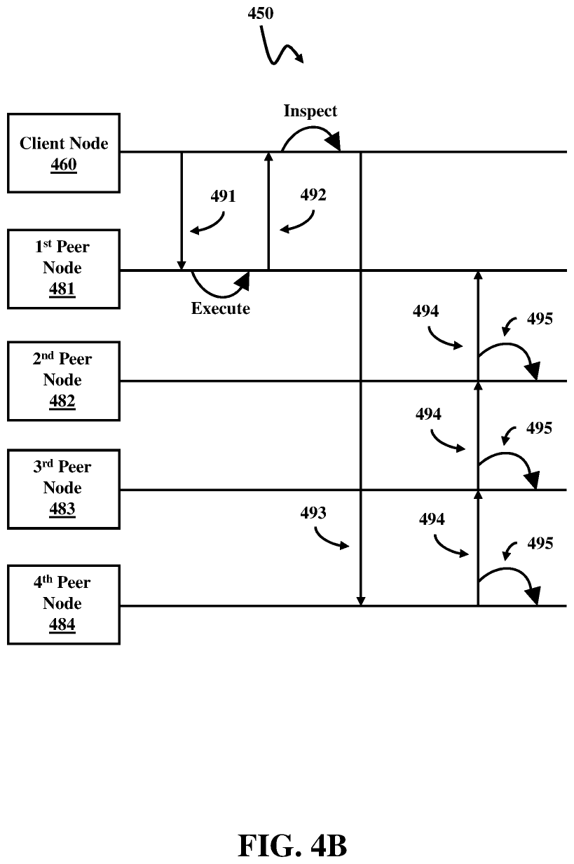

Smart contracts allow the performance of credible transactions which are trackable and irreversible. For example, if the transfer of cryptocurrency from the US to Germany through a Switzerland bank requires a fee to be paid to the Swiss government, a smart contract may be made where the final transfer may not be completed until the fee is paid. In some embodiments, the transfer of digital assets may involve the creation and completion of one or more smart contracts. Further information on smart contracts can be found in FIG. 4A. In some embodiments, the path object builder may include an audit system which is required by most regulated asset transfer networks. In some instances, the audit system may be a method of recordation for due diligence steps that were taken to comply with the requirements of the jurisdictions involved in the transactions. Following the example from above, the audit system may include what agency regulations were referenced for the US, Germany, and Switzerland, and how the regulations were comported with.

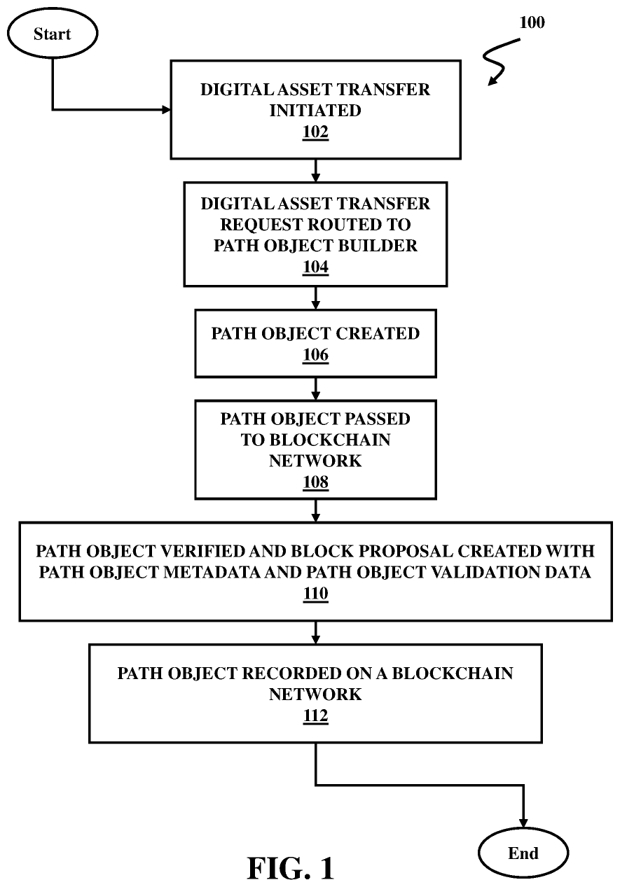

Referring now to FIG. 1, illustrated is a flowchart of an example method 100 for blockchain enabled model smart compliance, in accordance with embodiments of the present disclosure. In some embodiments, the method 100 is performed by a processor on a blockchain network or in communication with a blockchain network.

In some embodiments, the method 100 begins at operation 102, where a digital asset transfer is initiated. In some embodiments, the initiation may begin with a party creating a digital asset transfer request. For example, the digital asset transfer request may be a smart contract between company A in the US and company B in Germany, or the request may take other forms that may give a path object builder information on the transfer request. The initiation may come from one or more parties participating in the request, or it may come from a third party (e.g., a mediator in a settlement agreement, or a broker for a real estate deal). For example, company A may be using mediator M to handle the asset transfer contract/details and mediator M may create the transfer request.

In some embodiments, the digital asset transfer request may include information related to the asset such as, a list of terms in an agreement related to the asset transfer, a list of agents (e.g., a bank, a broker, a firm, a mediation organization, a representative, etc.) that may be representing either party in the transfer, a list of organizations or agents (e.g., a bank, a broker, a firm, a mediation organization, a representative, etc.) that may be facilitating the transfer of the digital assets, locations or jurisdictions for the agents, the type of assets to be transferred, and other information relating to the transfer. For example, the digital asset transfer request may include information such as, company A location US, company B location Germany, mediator M location Canada, bank S location Switzerland, and company A may transfer 100 exempli gratia dollars (fictional crypto currency) through bank S to company B. In some embodiments, the request may contain the data or a location of data in a distributed file storage. In some embodiments, some or all of the data may be contained in digital contracts on various blockchain networks. For example, in a simple two-party contract, each party may create a digital contract, where each contract contains the terms of the agreement that are important to the drafting party. Other possible ways of initiating digital asset transfers are possible.

With regard to some embodiments, a digital asset exists in a digital format (e.g., binary format) and comes with the right to use. Data that do not possess that right are not considered assets. Digital assets include but are not exclusive to: crypto currency, digital land titles, electronic titles, electronic liens digital documents, audible content, motion pictures, and other relevant digital data that are currently in circulation or stored on digital appliances such as: personal computers, laptops, portable media players, tablets, storage devices, telecommunication devices, and any and all apparatuses which are, or may be in existence once technology progresses to accommodate for the conception of new modalities which may be able to carry digital assets; notwithstanding the proprietorship of the physical device onto which the digital asset is located.

In some embodiments, the method 100 continues at operation 104, where the digital asset transfer request is routed to a path object builder. In some embodiments, the digital asset transfer request may be a copy of a contract for the asset transfer agreement, an entry on a blockchain network, a message, or another way of providing information on the digital asset transfer to the path object builder. For example, mediator M may forward a list of the terms of the contract or forward the contract to the path object builder. In some embodiments, the path object builder is a computer system that has been designed to take in information on digital assets and determine the classification, routing, and jurisdictional requirements for the transfer of digital assets.

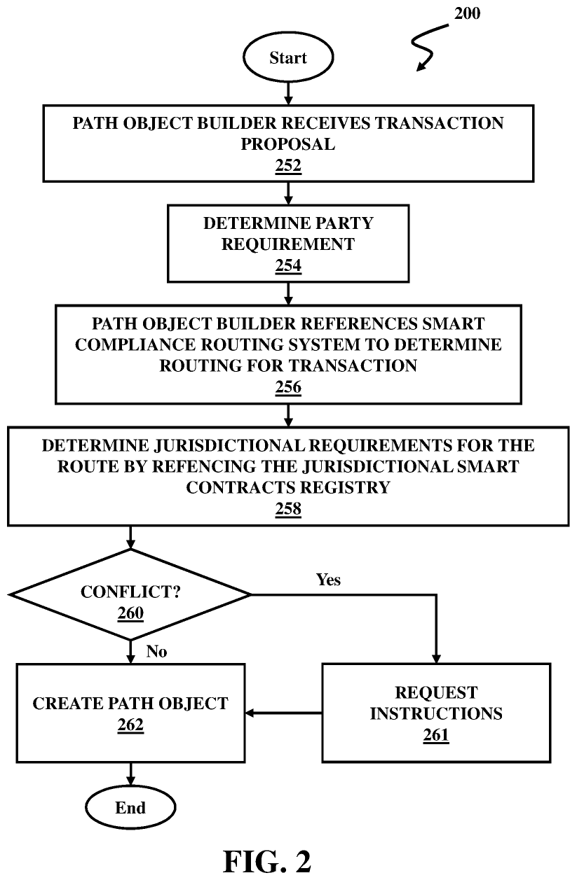

In some embodiments, the method 100 continues at operation 106, where the path object builder may create a path object. This step is described in more detail in FIG. 2. In some embodiments, a smart compliance routing system (described in more detail in FIG. 2) may work with a path object builder to determine information/requirements regarding the asset transfer such as the following:

a) Digital asset class classification including valuation, compliance code etc.

b) Jurisdiction/rules involved in the asset transfer

c) Travel rule of the digital asset, etc.

d) Digital asset defined meta data of asset such as asset half-life or time to live

e) Fee structure—based on asset type/cost of compliance jurisdictional imposed fees etc.

This information may be used to create the path object. In some embodiment, the information/requirements may be stored as metadata regarding the asset transfer. More detailed examples of the information/requirements follow.

With regard to some embodiments, digital asset class classification may be the details of the asset such as type, valuation, organizations that may control the asset type, and/or governing bodies that regulate the asset. For example, the classification for a dairy futures transfer may be 10,000 gallons of milk, a value of the futures at the signing of the contract, the Chicago Mercantile Exchange (CME) as the operating body of the transfer, big dairy LLC as the company providing the actual dairy, and the Commodity Futures Trading Commission (CFTC created by the Commodity Futures Trading Commission Act of 1974) as the governing body. Actual use cases may have different details as required by the participants, asset contracts, governing bodies, or other sources.

In regard to some embodiments, a jurisdiction/rule may be a source jurisdiction (governing body that regulates moving an asset and criteria needed to move an asset), a destination jurisdiction (governing body that regulates accepting an asset and criteria needed to accept the asset), another controlling jurisdictions (governing body that regulates any party or action involved in the transfer of an asset and criteria needed to transfer an asset), or any rules/bodies of laws that may dictate an asset transfer.

With regard to some embodiments, a travel rule, such as a Bank Secrecy Act (BSA) rule [31 CFR 103.33(g)], requires all financial institutions to pass on certain information to the next financial institution. The rules basically encompass two factors: keep track of the money every time it moves and record how the money travels from one place to another. The travel rule(s) often contain compliance burdens such as AML/KYC (Anti-Money Laundering/Know Your Customer) etc. KYC is a term used to describe how a business identifies and verifies the identity of a client. KYC is part of AML. An example rule covering both AML/KYC may “Profile Change Before Large Transaction.” This rule identifies a situation when a customer makes a profile change to personally identifiable information shortly before making a large transaction (in this example, a transaction greater than $750). This can indicate account takeover or potential “layering” activity to obscure the path of the funds. For example, if company A had a name change in the previous 30 days, the name change may trigger one or more other disclosure requirements.

In some embodiments, the path object builder may utilize an onboarding verification system to invoke the proper smart contracts to ensure that all participants of the asset transfer are onboarded following the relevant jurisdictional requirements. In some embodiments, an onboarding verification system ensures that as a part of onboarding the business entities the appropriate jurisdiction specific smart contracts are validated and available. For example, the onboarding verification system may ensure that KYC and other compliance systems of the jurisdiction are available—as this information may be used by the path object builder to determine the routing path and the access to available smart contracts in a jurisdictional smart contracts registry.

Digital asset defined meta data includes asset specific detail, such as asset half-life. For example, half-life is a term used to describe a future date when half of the total principal of a mortgage-backed security, or another form of debt or bond, may be paid off. While an estimate can be made as to what the half-life may be, it is not definite as the variables of the security or mortgage may change.

In regard to some embodiments, a fee structure is a chart or list highlighting the rates on various business services or activities and may include compliance rules for charging fees in specific jurisdictions. Fee structures describe the way that brokers or financial firms earn money from client business. There are many ways to structure fees, such as using an incentive-based model, charging commissions, or flat fee. For example, bank S may charge a flat fee of $1000.00 for any asset transfer.

As depicted in FIG. 1A, the method 100 continues at operation 108, where the path object may be passed to a blockchain network. In some embodiments, the path object builder is a node in the blockchain network and may initiate recording the path object on the distributed ledger. In some embodiments, the path object builder may pass the path object to a node on the blockchain network. For example, the path object builder may send the path object to company A with a node on the blockchain network, or directly to the node associated with company A, and the node may initiate recording the path object on the blockchain network.

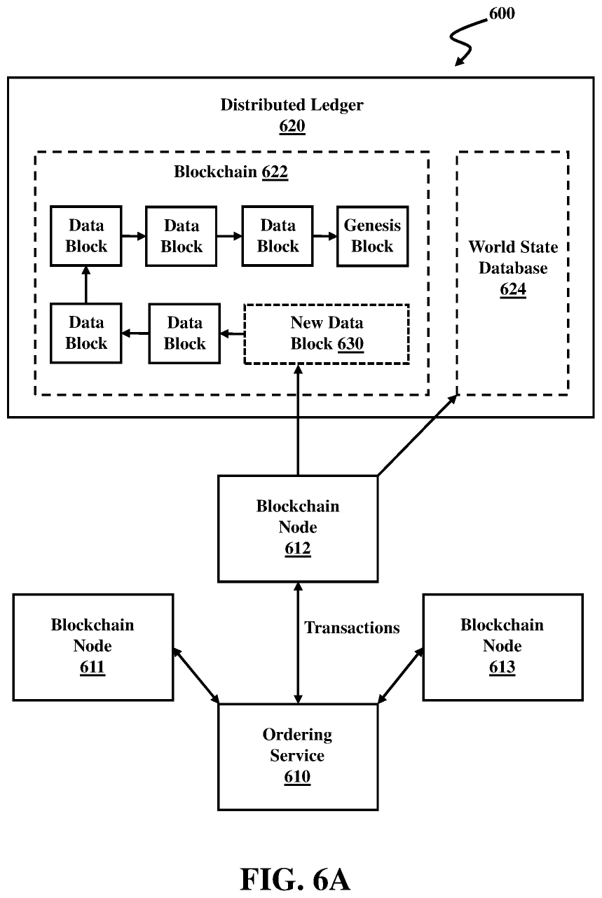

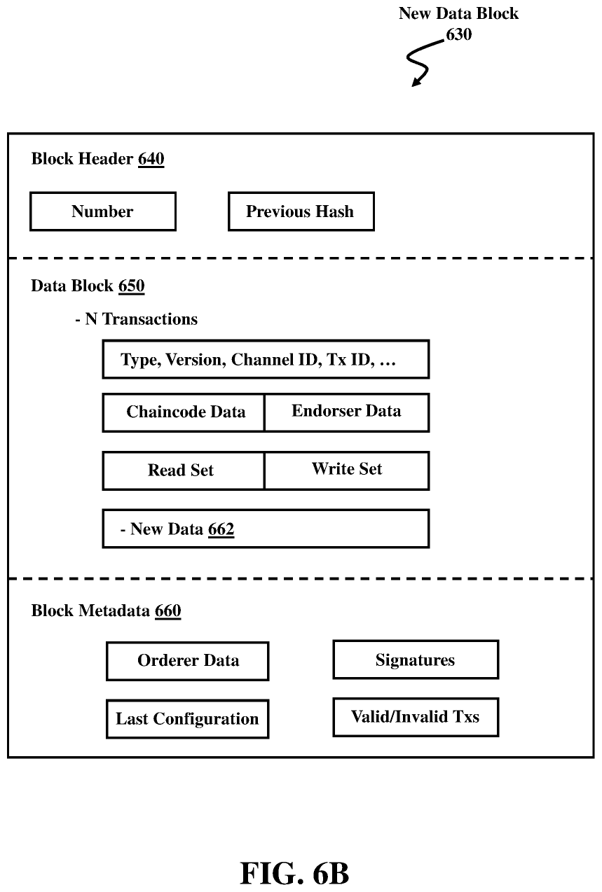

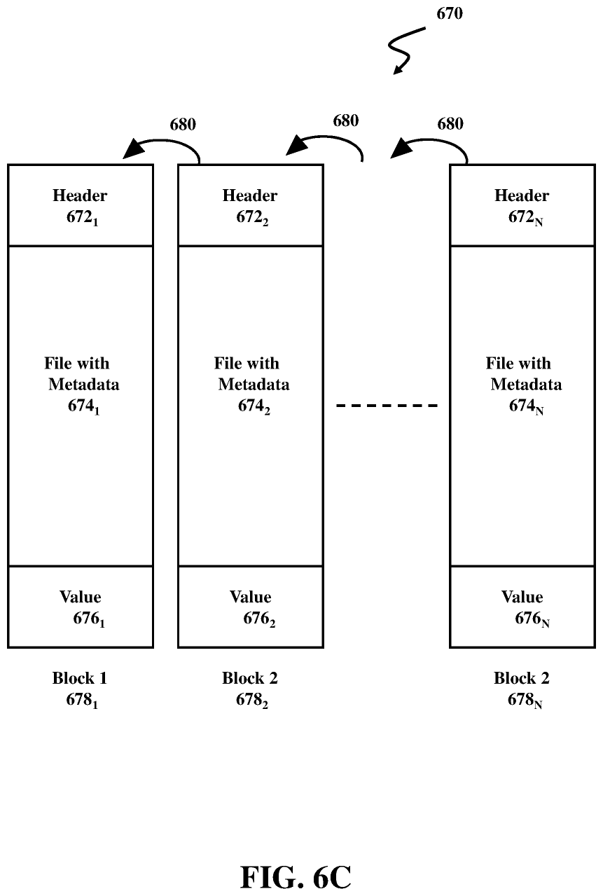

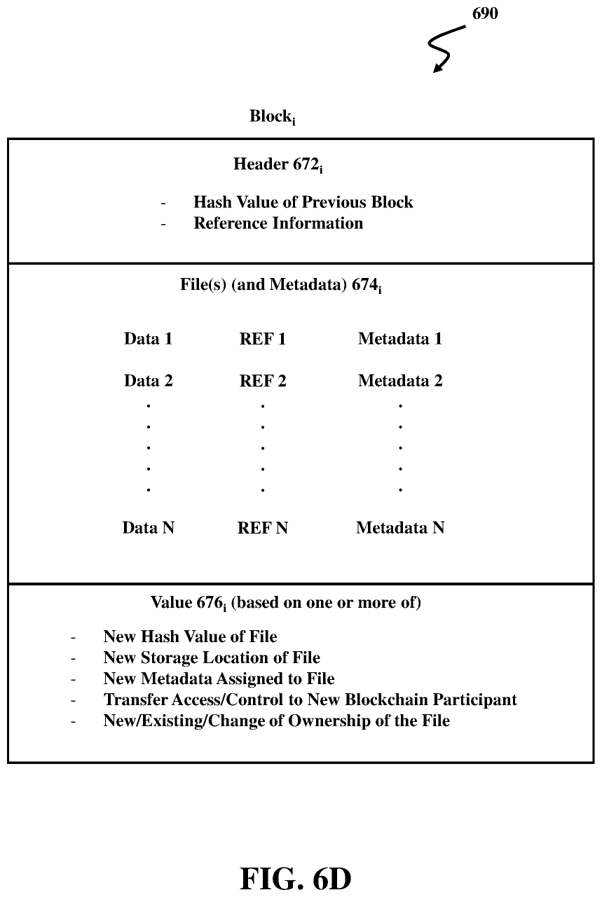

In some embodiments, the method 100 continues at operation 110, where the path object is verified and a block proposal (e.g., transaction proposal) is created. See blockchain transactional flow described in more detail in FIG. 4B. In some embodiments, the block proposal may include path object validation data, see FIG. 6B.

In some embodiments, the validation data may include one or more nodes verifying that the path object includes the necessary jurisdictions and has comported with required laws (e.g., due diligence). For example, a node associated with company A (based in the US) may verify that the path object includes and comports with US laws and company B (based in Germany) may verify that the path object includes and comports with German laws. In another example, company A may conduct due diligence to verify that the path object references all relevant jurisdictions for the asset transfer and comports with relevant laws.

By allowing each organization to verify all or a portion of the path object, unnecessary redundancy may be prevented while still allowing the flexibility to have redundancy as policies require. For example, if the internal policy of company A does not require company A to validate that German compliance requirements has been met, company A can rely on validation of German compliance requirements by company B. In an alternative example, if external or internal rules require that company A verify German compliance requirements, company A may validate the German compliance requirements even if company B has already verified the German compliance requirements.

In some embodiments, the method 100 continues at operation 112, where the path object may be recorded on a blockchain network. As stated in operation 106, the path object may contain the due diligence required for each jurisdiction that was part of the asset transfer. In some embodiments, recording the path objects on the blockchain network creates an immutable list of the due diligence performed for the asset transfer. In some embodiments, the path object may be accessible to the participants of the asset transfer to provide to one or more governing bodies. For example, if company A needs to show that the asset transfer comported with Canadian law, company A may direct the Canadian government to the blockchain ledger and the immutable list of all the due diligence steps taken to comply with Canadian law.

In some embodiments, the digital asset transfer state is recorded to the blockchain network in accordance with the path object. In some embodiments, the transfer state is the current phase of the asset transfer. For example, if an asset has moved from company A to bank S, the transfer state may be recorded as “asset transferred from company A to bank S.” after the asset has been transferred to company B, the transfer state may include an additional line stating “asset transferred from bank S to company B.” In some embodiments, a more detailed variation of block 106 is discussed in FIG. 2. In some embodiments, the transfer state also includes the path object requirements (e.g., jurisdictional requirements) that have been completed. For example, if the path object has a requirement that a fee be paid to the Swiss government, a line may state “fee X has been paid to the Swiss government.” Example, blockchain entries have been created for readability, actual entries may follow a different format.

Regarding FIG. 2, the method 200 begins at operation 252 where a path object builder receives a digital asset transfer request. In some embodiments, the digital asset transfer request (e.g., a proposed blockchain transaction) may include one or more details of a transaction. Some examples of the transaction details that may be included are one or more assets being exchanged, one or more services being rendered, two or more parties that are participating, one or more third parties being used to facilitate the transaction, one or more agents working for one or more of the parties, one or more regulatory organizations(e.g., governments, government departments, or regulatory bodies), one or more jurisdictions of the parties, the locations of the participants(e.g., parties, third parties, and/or agents), an asset transfer contract between the parties, details or terms of the contract, etc. In some embodiments, the transfer proposal may include an asset transfer contract or details of a contract between the parties. For example, the digital asset transfer request may include information such as, company A location US, company B location Germany, mediator M location Canada, bank S location Switzerland, and company A may transfer 200 exempli gratia dollars (fictional crypto currency) through bank S to company B. Other details of the asset transfer may be provided.

The method 200 continues at operation 254 where the path object builder may determine party requirements. In some embodiments, the party requirements may be one or more requirements the parties need to perform in order to complete the asset transfer. For example, company A (transferor) requires that the outgoing payment be in US dollars and company B (recipient) requires that it receives payment in exempli gratia dollars. In some embodiments, the party requirements may be derived from the transaction details. Following the previous example, the asset transfer contract may state that company A may send US dollars to bank S to convert into exempli gratia dollars and bank S may send the exempli gratia dollars to company B. Thus, the path object builder can determine that company A requires that the outgoing payment be in US dollars and company B requires that it receives payment in exempli gratia dollars. In some embodiments, the path object builder may send requests to the participants for additional information. For example, if the asset transfer contract did not specify what currency company A was going to pay with, the path object builder may request that information from mediator M or company A.

The method 200 continues at operation 256 where the path object builder references a smart compliance routing system to determine routing for the asset transfer. In some embodiments, the smart compliance routing system is a node capable of determining what jurisdictions may have influence or control over the performance or completion of the asset transfer. The smart contract routing apparatus may inspect the business elements of the digital asset transfer such as the participants of the transactions and what assets may be traded to determine the route (e.g., governing organizations for the transfer of the assets in each jurisdiction) that may need to be navigated in order to meet the due diligence requirements for each jurisdiction. For example, for an asset transfer between company A in the US and company B in Germany, the smart contract routing apparatus may determine that the system may have to comport with the regulations outlined by the Federal Trade Commission in the US and the Federal Cartel Office in Germany.

In some embodiments, the smart contract routing apparatus determines not only what governing bodies may control the asset transfer, but what regulations or laws may need to be followed. For example, the smart compliance system may identify the Bank Secrecy Act and 31 C.F.R. Part 501 (Treasury's Office of Foreign Assets Control reporting regulations) as two controlling regulation documents. In some embodiments, the smart compliance routing system and the path object builder may be part of the same computing system or they may be different computing systems.

Method 200 continues with operation 258 where the path object builder determines jurisdictional requirements for the route by referencing a jurisdictional smart contracts registry. In some instances, the jurisdictional smart contract registry may be a registry and storage mechanism of jurisdictional specific smart contracts. For example, the jurisdictional smart contract registry may be a distributed file storage. In some embodiments, a jurisdictional smart contract registry includes a registry and storage mechanism of jurisdictional specific smart contracts that the path object builder accesses to process the routes determined in operation 256.

In some embodiments, the path object builder retrieves jurisdictional smart contracts to build the path object in accordance with the determined route. For example, an asset transfer may need a smart contract for the US jurisdiction, company A, and the German jurisdiction, company B. The jurisdictional smart contracts may contain the specific steps required for abiding by the laws and requirements for a specific jurisdiction. For example, compliance requirements for crypto currency asset transfers in the US may have a designated smart contract, smart contract x, in the jurisdictional smart contract registry. If the US is involved in an asset transfer of crypto currency, the path object builder may extract smart contract x from the registry and use smart contract x in the building of the path object.

Using the jurisdictional smart contract registry, the path object builder determines the processing steps according to the assessed routes determined in operation 256 by identifying one or more smart contracts to comply with the jurisdictional requirements. Thus, the path object may be an agglomeration of smart contracts for different jurisdictional requirements. For example, for an asset transfer involving the US, Switzerland, and Germany, the path object builder may build the path object to include jurisdictional smart contracts from each country. In some embodiments, the path object builder may send requests to one or more regulatory bodies for other smart contracts or clarifying information on the jurisdictional smart contracts. For example, the path object builder may send a request to the controlling agency in Germany to determine if the parties need to comply with any special requirement (such as registering to trade crypto currency) in order to receive crypto currency.

Examples given herein are simplified for understanding, it may be understood that one jurisdiction may have multiple smart contracts addressing multiple policies or organization. For example, company A may operate in multiple states, each state may have a controlling agency along with one or more federal controlling agencies. Each agency may have a set of regulations that need to be complied with and thus each agency may have a smart contract associated with relevant regulations.

In some embodiments, the processing may include confirming that controlling entities for each jurisdiction have been identified. If a controlling entity has not been identified a request may be sent to one or more of the participants of the asset transfer. For example, if company B is based in Germany and no controlling agency has been identified, a request for the controlling agency may be sent to one or more of the participants (e.g., Company B).

Method 200 may continue with operation 260 where it may be determined if there is a conflict. The conflict check may determine if there is any operational conflict between any of the asset transfer requirements for any of the participants or any of the jurisdictional requirements. For example, if company A requires that the asset transfer occurs on Mar. 7, 2025 and company B requires that the asset transfer occurs on Dec. 6, 2025, there may be a conflict. In another example, if the US jurisdiction requires a holding of assets for one month but a German jurisdiction requires that the holding period lasts no more than 2 weeks, there may be a conflict. If there is no conflict, the path object builder may create the path object in operation 262. If there is a conflict, the path object builder may move to operation 261 where it may request instructions from one of the participants of the asset transfer. For example, if a conflict is detected, the path object builder may send a request to mediator M, and mediator M may send instructions on how to resolve the conflict during the path object creation in operation 262.

In operation 262, the path object builder may create the path object. In some embodiments, the path object may involve linking the smart contracts that were selected in operation 258. For example, if a smart contract for US regulations and the smart contract for German regulations both include a holding period (that does invoke a conflict), the path object my link those holding requirements so that they may be completed with a single hold. In some embodiments, the path object may include any conflict resolution instructions received in operation 261. Following the example above, the path object builder may have received instructions to follow the US holding requirements of one month instead of the German requirements for no more than one week. In some embodiments, the path object may be a smart contract or agglomeration of smart contracts that may detail the due diligence requirements for the jurisdictions involved in a digital asset transfer.

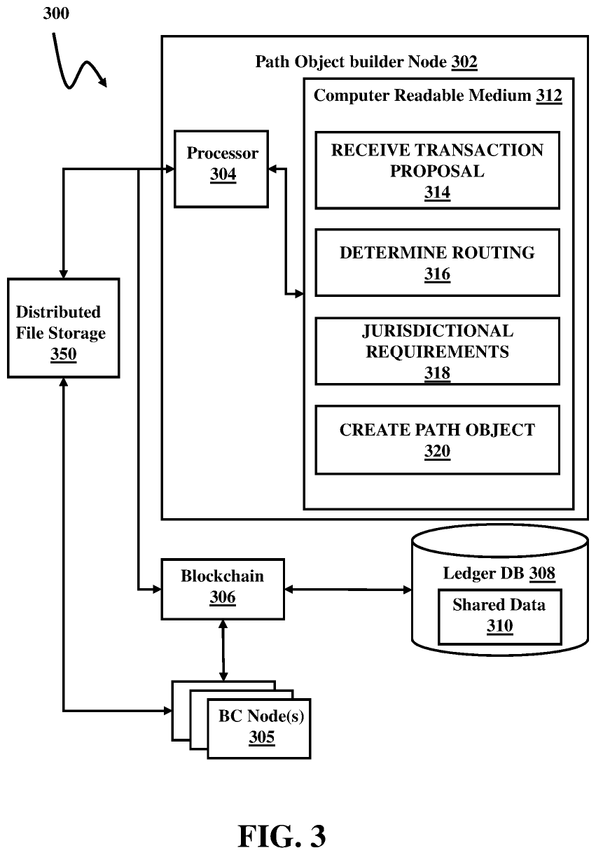

FIG. 3 illustrates a logic network diagram for smart data annotation in blockchain networks, according to example embodiments.

Referring to FIG. 3, the example network 300 includes a path object builder node 302 connected to other blockchain (BC) nodes 305 representing document-owner organizations. The path object builder node 302 may be connected to a blockchain 306 that has a ledger 308 for storing data to be shared (310) among the nodes 305. While this example describes in detail only one path object builder node 302, multiple such nodes may be connected to the blockchain 306. It should be understood that the path object builder node 302 may include additional components and that some of the components described herein may be removed and/or modified without departing from a scope of the path object builder node 302 disclosed herein. The path object builder node 302 may be a computing device or a server computer, or the like, and may include a processor 304, which may be a semiconductor-based microprocessor, a central processing unit (CPU), an application specific integrated circuit (ASIC), a field-programmable gate array (FPGA), and/or another hardware device. Although a single processor 304 is depicted, it should be understood that the path object builder node 302 may include multiple processors, multiple cores, or the like, without departing from the scope of the path object builder node 302 system. A distributed file storage 350 may be accessible to processor node 302 and other BC nodes 305. The distributed file storage may be used to store documents identified in ledger (distributed file storage) 350.

The path object builder node 302 may also include a non-transitory computer readable medium 312 that may have stored thereon machine-readable instructions executable by the processor 304. Examples of the machine-readable instructions are shown as 314-320 and are further discussed below. Examples of the non-transitory computer readable medium 312 may include an electronic, magnetic, optical, or other physical storage device that contains or stores executable instructions. For example, the non-transitory computer readable medium 312 may be a Random Access memory (RAM), an Electrically Erasable Programmable Read-Only Memory (EEPROM), a hard disk, an optical disc, or other type of storage device.

The processor 304 may execute the machine-readable instructions 314 to receive a digital asset transfer request. As discussed above, the blockchain ledger 308 may store data to be shared among the nodes 305. The blockchain 306 network may be configured to use one or more smart contracts that manage transactions for multiple participating nodes. Documents linked to the annotation information may be stored in distributed file storage 350. The processor 304 may execute the machine-readable instructions 316 to reference a smart compliance routing system to determine routing for the asset transfer. The processor 304 may execute the machine-readable instructions 318 to determine jurisdictional requirements for the route by referencing a jurisdictional smart contracts registry. The processor 304 may execute the machine-readable instructions 320 to create the path object.

FIG. 4A illustrates a blockchain architecture configuration 400, according to example embodiments. Referring to FIG. 4A, the blockchain architecture 400 may include certain blockchain elements, for example, a group of blockchain nodes 402. The blockchain nodes 402 may include one or more peer nodes 404-210 (these four nodes are depicted by example only). These nodes participate in a number of activities, such as blockchain transaction addition and validation process (consensus). One or more of the blockchain nodes 404-410 may endorse transactions based on endorsement policy and may provide an ordering service for all blockchain nodes in the architecture 400. A blockchain node may initiate a blockchain authentication and seek to write to a blockchain immutable ledger stored in blockchain layer 416, a copy of which may also be stored on the underpinning physical infrastructure 414. The blockchain configuration may include one or more applications 424 which are linked to application programming interfaces (APIs) 422 to access and execute stored program/application code 420 (e.g., chaincode, smart contracts, etc.) which can be created according to a customized configuration sought by participants and can maintain their own state, control their own assets, and receive external information. This can be deployed as a transaction and installed, via appending to the distributed ledger, on all blockchain nodes 404-410.

The blockchain base or platform 412 may include various layers of blockchain data, services (e.g., cryptographic trust services, virtual execution environment, etc.), and underpinning physical computer infrastructure that may be used to receive and store new transactions and provide access to auditors which are seeking to access data entries. The blockchain layer 416 may expose an interface that provides access to the virtual execution environment necessary to process the program code and engage the physical infrastructure 414. Cryptographic trust services 418 may be used to verify transactions such as asset exchange transactions and keep information private.

The blockchain architecture configuration of FIG. 4A may process and execute program/application code 420 via one or more interfaces exposed, and services provided, by blockchain platform 412. The code 420 may control blockchain assets. For example, the code 420 can store and transfer data, and may be executed by nodes 404-410 in the form of a smart contract and associated chaincode with conditions or other code elements subject to its execution. As a non-limiting example, smart contracts may be created to execute reminders, updates, and/or other notifications subject to the changes, updates, etc. The smart contracts can themselves be used to identify rules associated with authorization and access requirements and usage of the ledger. For example, the document attribute(s) information 426 may be processed by one or more processing entities (e.g., virtual machines) included in the blockchain layer 416. The result 428 may include a plurality of linked shared documents. The physical infrastructure 414 may be utilized to retrieve any of the data or information described herein.

A smart contract may be created via a high-level application and programming language, and then written to a block in the blockchain. The smart contract may include executable code which is registered, stored, and/or replicated with a blockchain (e.g., distributed network of blockchain peers). A transaction is an execution of the smart contract code which can be performed in response to conditions associated with the smart contract being satisfied. The executing of the smart contract may trigger a trusted modification(s) to a state of a digital blockchain ledger. The modification(s) to the blockchain ledger caused by the smart contract execution may be automatically replicated throughout the distributed network of blockchain peers through one or more consensus protocols.

The smart contract may write data to the blockchain in the format of key-value pairs. Furthermore, the smart contract code can read the values stored in a blockchain and use them in application operations. The smart contract code can write the output of various logic operations into the blockchain. The code may be used to create a temporary data structure in a virtual machine or other computing platform. Data written to the blockchain can be public and/or can be encrypted and maintained as private. The temporary data that is used/generated by the smart contract is held in memory by the supplied execution environment, then deleted once the data needed for the blockchain is identified.

A chaincode may include the code interpretation of a smart contract, with additional features. As described herein, the chaincode may be program code deployed on a computing network, where it is executed and validated by chain validators together during a consensus process. The chaincode receives a hash and retrieves from the blockchain a hash associated with the data template created by use of a previously stored feature extractor. If the hashes of the hash identifier and the hash created from the stored identifier template data match, then the chaincode sends an authorization key to the requested service. The chaincode may write to the blockchain data associated with the cryptographic details.

FIG. 4B illustrates an example of a blockchain transactional flow 450 between nodes of the blockchain in accordance with an example embodiment. Referring to FIG. 4B a general description of transactional flow 450 will be given followed by a more specific example. The transaction flow may include a transaction proposal 491 sent by an application client node 460 to an endorsing peer node 481. The endorsing peer 481 may verify the client signature and execute a chaincode function to initiate the transaction. The output may include the chaincode results, a set of key/value versions that were read in the chaincode (read set), and the set of keys/values that were written in chaincode (write set). The proposal response 492 is sent back to the client 460 along with an endorsement signature, if approved. The client 460 assembles the endorsements into a transaction payload 493 and broadcasts it to an ordering service node 484. The ordering service node 484 then delivers ordered transactions as blocks to all peers 481-483 on a channel. Before committal to the blockchain, each peer 481-483 may validate the transaction. For example, the peers may check the endorsement policy to ensure that the correct allotment of the specified peers have signed the results and authenticated the signatures against the transaction payload 493. In some embodiments, one or more of the peers may be the manager nodes.

A more specific description of transactional flow 450 can be understood with a more specific example. To begin, the client node 460 initiates the transaction 491 by constructing and sending a request to the peer node 481, which is an endorser. The client 460 may include an application leveraging a supported software development kit (SDK), which utilizes an available API to generate a transaction proposal. The proposal is a request to invoke a chaincode function so that data can be read and/or written to the ledger (i.e., write new key value pairs for the assets). The SDK may serve as a shim to package the transaction proposal into a properly architected format (e.g., protocol buffer over a remote procedure call (RPC)) and take the client's cryptographic credentials to produce a unique signature for the transaction proposal.

In response, the endorsing peer node 481 may verify (a) that the transaction proposal is well formed, (b) the transaction has not been submitted already in the past (replay-attack protection), (c) the signature is valid, and (d) that the submitter (client 460, in the example) is properly authorized to perform the proposed operation on that channel. The endorsing peer node 481 may take the transaction proposal inputs as arguments to the invoked chaincode function. The chaincode is then executed against a current state database to produce transaction results including a response value, read set, and write set. However, no updates are made to the ledger at this point. In 492, the set of values, along with the endorsing peer node's 481 signature is passed back as a proposal response 492 to the SDK of the client 460 which parses the payload for the application to consume.

In response, the application of the client 460 inspects/verifies the endorsing peers signatures and compares the proposal responses to determine if the proposal response is the same. If the chaincode only queried the ledger, the application would inspect the query response and would typically not submit the transaction to the ordering service node 484. If the client application intends to submit the transaction to the ordering node service 484 to update the ledger, the application determines if the specified endorsement policy has been fulfilled before submitting (i.e., did all peer nodes necessary for the transaction endorse the transaction). Here, the client may include only one of multiple parties to the transaction. In this case, each client may have their own endorsing node, and each endorsing node may need to endorse the transaction. The architecture is such that even if an application selects not to inspect responses or otherwise forwards an unendorsed transaction, the endorsement policy may still be enforced by peers and upheld at the commit validation phase.

After successful inspection, the client 460 assembles endorsements into a transaction 493 and broadcasts the transaction proposal and response within a transaction message to the ordering node 484. The transaction may contain the read/write sets, the endorsing peers signatures and a channel ID. The ordering node 484 does not need to inspect the entire content of a transaction in order to perform its operation. Instead, the ordering node 484 may simply receive transactions from all channels in the network, order them chronologically by channel, and create blocks of transactions per channel.

The blocks of the transaction are delivered from the ordering node 484 to all peer nodes 481-483 on the channel. The transactions 494 within the block are validated to ensure any endorsement policy is fulfilled and to ensure that there have been no changes to ledger state for read set variables since the read set was generated by the transaction execution. Transactions in the block are tagged as being valid or invalid. Furthermore, in step 495 each peer node 481-483 appends the block to the channel's chain, and for each valid transaction the write sets are committed to current state database. An event is emitted to notify the client application that the transaction (invocation) has been immutably appended to the chain, as well as to notify whether the transaction was validated or invalidated.

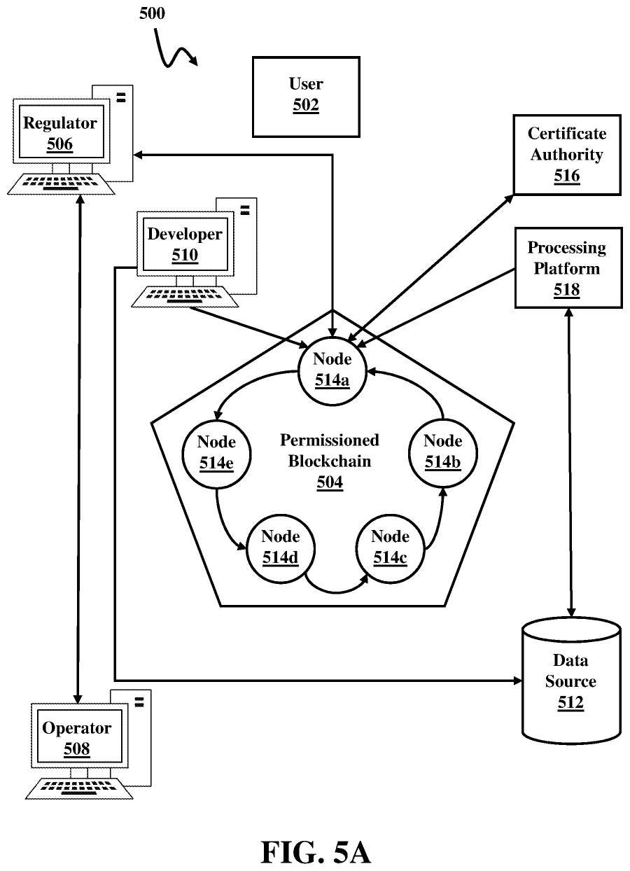

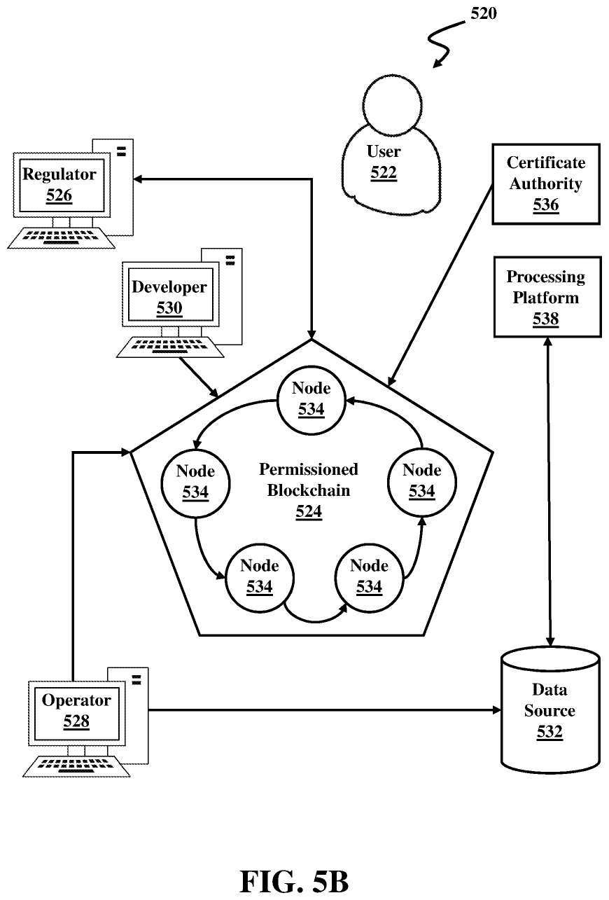

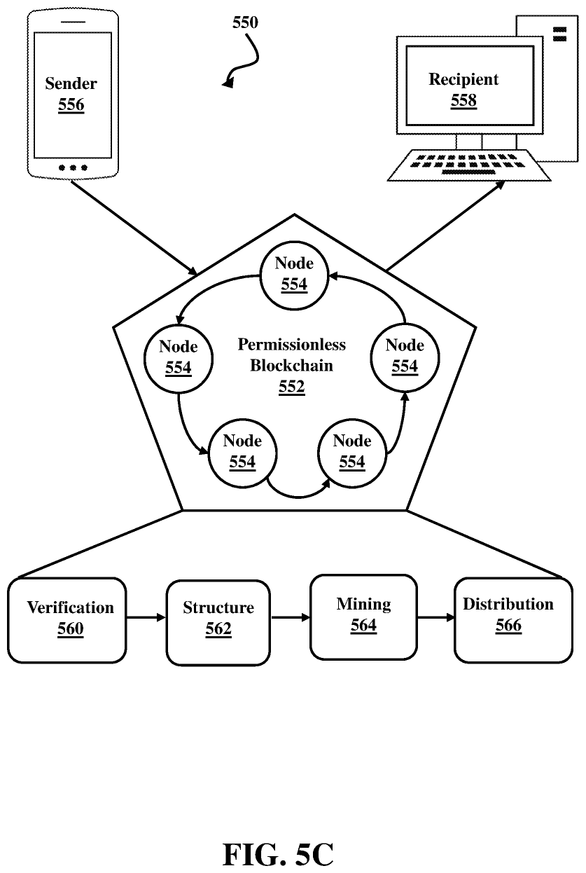

FIG. 5A illustrates an example of a permissioned blockchain network 500, which features a distributed, decentralized peer-to-peer architecture. In this example, a blockchain user 502 may initiate a transaction to the permissioned blockchain 504. In this example, the transaction can be a deploy, invoke, or query, and may be issued through a client-side application leveraging an SDK, directly through an API, etc. Networks may provide access to a regulator 506, such as an auditor. A blockchain network operator 508 manages member permissions, such as enrolling the regulator 506 as an “auditor” and the blockchain user 502 as a “client.” An auditor may be restricted only to querying the ledger whereas a client may be authorized to deploy, invoke, and query certain types of chaincode.

A blockchain developer 510 can write chaincode and client-side applications. The blockchain developer 510 can deploy chaincode directly to the network through an interface. To include credentials from a traditional data source 512 in chaincode, the developer 510 may use an out-of-band connection to access the data. In this example, the blockchain user 502 connects to the permissioned blockchain 504 through one of peer nodes 514 (referring to any one of nodes 514a-e). Before proceeding with any transactions, the peer node 514 (e.g., node 514a) retrieves the user's enrollment and transaction certificates from a certificate authority 516, which manages user roles and permissions. In some cases, blockchain users must possess these digital certificates in order to transact on the permissioned blockchain 504. Meanwhile, a user attempting to utilize chaincode may be required to verify their credentials on the traditional data source 512. To confirm the user's authorization, chaincode can use an out-of-band connection to this data through a traditional processing platform 518.

FIG. 5B illustrates another example of a permissioned blockchain network 520, which features a distributed, decentralized peer-to-peer architecture. In this example, a blockchain user 522 may submit a transaction to the permissioned blockchain 524. In this example, the transaction can be a deploy, invoke, or query, and may be issued through a client-side application leveraging an SDK, directly through an API, etc. Networks may provide access to a regulator 526, such as an auditor. A blockchain network operator 528 manages member permissions, such as enrolling the regulator 526 as an “auditor” and the blockchain user 522 as a “client.” An auditor may be restricted to only querying the ledger whereas a client may be authorized to deploy, invoke, and query certain types of chaincode.

A blockchain developer 530 writes chaincode and client-side applications. The blockchain developer 530 can deploy chaincode directly to the network through an interface. To include credentials from a traditional data source 532 in chaincode, the developer 530 may use an out-of-band connection to access the data. In this example, the blockchain user 522 connects to the network through a peer node 534. Before proceeding with any transactions, the peer node 534 retrieves the user's enrollment and transaction certificates from the certificate authority 536. In some cases, blockchain users must possess these digital certificates in order to transact on the permissioned blockchain 524. Meanwhile, a user attempting to utilize chaincode may be required to verify their credentials on the traditional data source 532. To confirm the user's authorization, chaincode can use an out-of-band connection to this data through a traditional processing platform 538.

In some embodiments of the present disclosure, the blockchain herein may be a permissionless blockchain. In contrast with permissioned blockchains which require permission to join, anyone can join a permissionless blockchain. For example, to join a permissionless blockchain a user may create a personal address and begin interacting with the network, by submitting transactions, and hence adding entries to the ledger. Additionally, all parties have the choice of running a node on the system and employing the mining protocols to help verify transactions.

FIG. 5C illustrates a process 550 of a transaction being processed by a permissionless blockchain 552 including a plurality of nodes 554. A sender 556 desires to send payment or some other form of value (e.g., a deed, medical records, a contract, a good, a service, or any other asset that can be encapsulated in a digital record) to a recipient 558 via the permissionless blockchain 552. In some embodiments, each of the sender device 556 and the recipient device 558 may have digital wallets (associated with the blockchain 552) that provide user interface controls and a display of transaction parameters. In response, the transaction is broadcast throughout the blockchain 552 to the nodes 554.

Depending on the blockchain's 552 network parameters the nodes verify 560 the transaction based on rules (which may be pre-defined or dynamically allocated) established by the permissionless blockchain 552 creators. For example, this may include verifying identities of the parties involved, etc. The transaction may be verified immediately or it may be placed in a queue with other transactions and the nodes 554 determine if the transactions are valid based on a set of network rules.

In structure 562, valid transactions are formed into a block and sealed with a lock (hash). This process may be performed by mining nodes among the nodes 554. Mining nodes may utilize additional software specifically for mining and creating blocks for the permissionless blockchain 552. Each block may be identified by a hash (e.g., 256 bit number, etc.) created using an algorithm agreed upon by the network. Each block may include a header, a pointer or reference to a hash of a previous block's header in the chain, and a group of valid transactions. The reference to the previous block's hash is associated with the creation of the secure independent chain of blocks.

Before blocks can be added to the blockchain, the blocks must be validated. Validation for the permissionless blockchain 552 may include a proof-of-work (PoW) which is a solution to a puzzle derived from the block's header. Although not shown in the example of FIG. 5C, another process for validating a block is proof-of-stake. Unlike the proof-of-work, where the algorithm rewards miners who solve mathematical problems, with the proof of stake, a creator of a new block is chosen in a deterministic way, depending on its wealth, also defined as “stake.” Then, a similar proof is performed by the selected/chosen node.

With mining 564, nodes try to solve the block by making incremental changes to one variable until the solution satisfies a network-wide target. This creates the PoW thereby ensuring correct answers. In other words, a potential solution must prove that computing resources were drained in solving the problem. In some types of permissionless blockchains, miners may be rewarded with value (e.g., coins, etc.) for correctly mining a block.

Here, the PoW process, alongside the chaining of blocks, makes modifications of the blockchain extremely difficult, as an attacker must modify all subsequent blocks in order for the modifications of one block to be accepted. Furthermore, as new blocks are mined, the difficulty of modifying a block increases, and the number of subsequent blocks increases. With distribution 566, the successfully validated block is distributed through the permissionless blockchain 552 and all nodes 554 add the block to a majority chain which is the permissionless blockchain's 552 auditable ledger. Furthermore, the value in the transaction submitted by the sender 556 is deposited or otherwise transferred to the digital wallet of the recipient device 558.

FIG. 6A illustrates a process 600 of a new block being added to a distributed ledger 620, according to example embodiments, and FIG. 6B illustrates contents of a new data block structure 630 for blockchain, according to example embodiments. The new data block 630 may contain document linking data.

Referring to FIG. 6A, clients (not shown) may submit transactions to blockchain nodes 611, 612, and/or 613. Clients may be instructions received from any source to enact activity on the blockchain 620. As an example, clients may be applications that act on behalf of a requester, such as a device, person or entity to propose transactions for the blockchain. The plurality of blockchain peers (e.g., blockchain nodes 611, 612, and 613) may maintain a state of the blockchain network and a copy of the distributed ledger 620. Different types of blockchain nodes/peers may be present in the blockchain network including endorsing peers which simulate and endorse transactions proposed by clients and committing peers which verify endorsements, validate transactions, and commit transactions to the distributed ledger 620. In this example, the blockchain nodes 611, 612, and 613 may perform the role of endorser node, committer node, or both.

The distributed ledger 620 includes a blockchain which stores immutable, sequenced records in blocks, and a state database 624 (current world state) maintaining a current state of the blockchain 622. One distributed ledger 620 may exist per channel and each peer maintains its own copy of the distributed ledger 620 for each channel of which they are a member. The blockchain 622 is a transaction log, structured as hash-linked blocks where each block contains a sequence of N transactions. Blocks may include various components such as shown in FIG. 6B. The linking of the blocks (shown by arrows in FIG. 6A) may be generated by adding a hash of a prior block's header within a block header of a current block. In this way, all transactions on the blockchain 622 are sequenced and cryptographically linked together preventing tampering with blockchain data without breaking the hash links. Furthermore, because of the links, the latest block in the blockchain 622 represents every transaction that has come before it. The blockchain 622 may be stored on a peer file system (local or attached storage), which supports an append-only blockchain workload.

The current state of the blockchain 622 and the distributed ledger 622 may be stored in the state database 624. Here, the current state data represents the latest values for all keys ever included in the chain transaction log of the blockchain 622. Chaincode invocations execute transactions against the current state in the state database 624. To make these chaincode interactions extremely efficient, the latest values of all keys are stored in the state database 624. The state database 624 may include an indexed view into the transaction log of the blockchain 622, it can therefore be regenerated from the chain at any time. The state database 624 may automatically get recovered (or generated if needed) upon peer startup, before transactions are accepted.

Endorsing nodes receive transactions from clients and endorse the transaction based on simulated results. Endorsing nodes hold smart contracts which simulate the transaction proposals. When an endorsing node endorses a transaction, the endorsing node creates a transaction endorsement which is a signed response from the endorsing node to the client application indicating the endorsement of the simulated transaction. The method of endorsing a transaction depends on an endorsement policy which may be specified within chaincode. An example of an endorsement policy is “the majority of endorsing peers must endorse the transaction.” Different channels may have different endorsement policies. Endorsed transactions are forward by the client application to ordering service 610.

The ordering service 610 accepts endorsed transactions, orders them into a block, and delivers the blocks to the committing peers. For example, the ordering service 610 may initiate a new block when a threshold of transactions has been reached, a timer times out, or another condition. In the example of FIG. 6A, blockchain node 612 is a committing peer that has received a new data new data block 630 for storage on blockchain 620. The first block in the blockchain may be referred to as a genesis block which includes information about the blockchain, its members, the data stored therein, etc.

The ordering service 610 may be made up of a cluster of orderers. The ordering service 610 does not process transactions, smart contracts, or maintain the shared ledger. Rather, the ordering service 610 may accept the endorsed transactions and specifies the order in which those transactions are committed to the distributed ledger 620. The architecture of the blockchain network may be designed such that the specific implementation of ‘ordering’ (e.g., Solo, Kafka, BFT, etc.) becomes a pluggable component.

Transactions are written to the distributed ledger 620 in a consistent order. The order of transactions is established to ensure that the updates to the state database 624 are valid when they are committed to the network. Unlike a cryptocurrency blockchain system (e.g., Bitcoin, etc.) where ordering occurs through the solving of a cryptographic puzzle, or mining, in this example the parties of the distributed ledger 620 may choose the ordering mechanism that best suits that network.

When the ordering service 610 initializes a new data block 630, the new data block 630 may be broadcast to committing peers (e.g., blockchain nodes 611, 612, and 613). In response, each committing peer validates the transaction within the new data block 630 by checking to make sure that the read set and the write set still match the current world state in the state database 624. Specifically, the committing peer can determine whether the read data that existed when the endorsers simulated the transaction is identical to the current world state in the state database 624. When the committing peer validates the transaction, the transaction is written to the blockchain 622 on the distributed ledger 620, and the state database 624 is updated with the write data from the read-write set. If a transaction fails, that is, if the committing peer finds that the read-write set does not match the current world state in the state database 624, the transaction ordered into a block may still be included in that block, but it may be marked as invalid, and the state database 624 may not be updated.

Referring to FIG. 6B, a new data block 630 (also referred to as a data block) that is stored on the blockchain 622 of the distributed ledger 620 may include multiple data segments such as a block header 640, block data 650, and block metadata 660. It should be appreciated that the various depicted blocks and their contents, such as new data block 630 and its contents. Shown in FIG. 6B are merely examples and are not meant to limit the scope of the example embodiments. The new data block 630 may store transactional information of N transaction(s) (e.g., 1, 10, 100, 500, 1000, 2000, 3000, etc.) within the block data 650. The new data block 630 may also include a link to a previous block (e.g., on the blockchain 622 in FIG. 6A) within the block header 640. In particular, the block header 640 may include a hash of a previous block's header. The block header 640 may also include a unique block number, a hash of the block data 650 of the new data block 630, and the like. The block number of the new data block 630 may be unique and assigned in various orders, such as an incremental/sequential order starting from zero.

The block data 650 may store transactional information of each transaction that is recorded within the new data block 630. For example, the transaction data may include one or more of a type of the transaction, a version, a timestamp, a channel ID of the distributed ledger 620, a transaction ID, an epoch, a payload visibility, a chaincode path (deploy tx), a chaincode name, a chaincode version, input (chaincode and functions), a client (creator) identify such as a public key and certificate, a signature of the client, identities of endorsers, endorser signatures, a proposal hash, chaincode events, response status, namespace, a read set (list of key and version read by the transaction, etc.), a write set (list of key and value, etc.), a start key, an end key, a list of keys, a Merkel tree query summary, and the like. The transaction data may be stored for each of the N transactions.

In some embodiments, the block data 650 may also store new data 662 which adds additional information to the hash-linked chain of blocks in the blockchain 622. The additional information includes one or more of the steps, features, processes and/or actions described or depicted herein. Accordingly, the new data 662 can be stored in an immutable log of blocks on the distributed ledger 620. Some of the benefits of storing such new data 662 are reflected in the various embodiments disclosed and depicted herein. Although in FIG. 6B the new data 662 is depicted in the block data 650 but may also be located in the block header 640 or the block metadata 660. The new data 662 may include a document composite key that is used for linking the documents within an organization.

The block metadata 660 may store multiple fields of metadata (e.g., as a byte array, etc.). Metadata fields may include signature on block creation, a reference to a last configuration block, a transaction filter identifying valid and invalid transactions within the block, last offset persisted of an ordering service that ordered the block, and the like. The signature, the last configuration block, and the orderer metadata may be added by the ordering service 610. Meanwhile, a committer of the block (such as blockchain node 612) may add validity/invalidity information based on an endorsement policy, verification of read/write sets, and the like. The transaction filter may include a byte array of a size equal to the number of transactions in the block data 650 and a validation code identifying whether a transaction was valid/invalid.

FIG. 6C illustrates an embodiment of a blockchain 670 for digital content in accordance with the embodiments described herein. The digital content may include one or more files and associated information. The files may include media, images, video, audio, text, links, graphics, animations, web pages, documents, or other forms of digital content. The immutable, append-only aspects of the blockchain serve as a safeguard to protect the integrity, validity, and authenticity of the digital content, making it suitable use in legal proceedings where admissibility rules apply or other settings where evidence is taken in to consideration or where the presentation and use of digital information is otherwise of interest. In this case, the digital content may be referred to as digital evidence.

The blockchain may be formed in various ways. In some embodiments, the digital content may be included in and accessed from the blockchain itself. For example, each block of the blockchain may store a hash value of reference information (e.g., header, value, etc.) along the associated digital content. The hash value and associated digital content may then be encrypted together. Thus, the digital content of each block may be accessed by decrypting each block in the blockchain, and the hash value of each block may be used as a basis to reference a previous block. This may be illustrated as follows:

| Block 1 | Block 2 | . . . | Block N |
|---|---|---|---|
| Hash Value 1 | Hash Value 2 | | Hash Value N |
| Digital Content 1 | Digital Content 2 | | Digital Content N |

In some embodiments, the digital content may be not included in the blockchain. For example, the blockchain may store the encrypted hashes of the content of each block without any of the digital content. The digital content may be stored in another storage area or memory address in association with the hash value of the original file. The other storage area may be the same storage device used to store the blockchain or may be a different storage area or even a separate relational database. The digital content of each block may be referenced or accessed by obtaining or querying the hash value of a block of interest and then looking up that has value in the storage area, which is stored in correspondence with the actual digital content. This operation may be performed, for example, a database gatekeeper. This may be illustrated as follows:

| Blockchain | Storage Area |
|---|---|
| Block 1 Hash Value | Block 1 Hash Value . . . Content |
| . | . |
| . | . |
| . | . |
| Block N Hash Value | Block N Hash Value . . . Content |

In the example embodiment of FIG. 6C, the blockchain 670 includes a number of blocks 6781, 6782, . . . 678N cryptographically linked in an ordered sequence, where N≥1. The encryption used to link the blocks 6781, 6782, . . . 678N may be any of a number of keyed or un-keyed Hash functions. In some embodiments, the blocks 6781, 6782, . . . 678N are subject to a hash function which produces n-bit alphanumeric outputs (where n is 256 or another number) from inputs that are based on information in the blocks. Examples of such a hash function include, but are not limited to, a SHA-type (SHA stands for Secured Hash Algorithm) algorithm, Merkle-Damgard algorithm, HAIFA algorithm, Merkle-tree algorithm, nonce-based algorithm, and a non-collision-resistant PRF algorithm. In other embodiments, the blocks 6781, 6782, . . . , 678N may be cryptographically linked by a function that is different from a hash function. For purposes of illustration, the following description is made with reference to a hash function, e.g., SHA-2.

Each of the blocks 6781, 6782, . . . , 678N in the blockchain includes a header, a version of the file, and a value. The header and the value are different for each block as a result of hashing in the blockchain. In some embodiments, the value may be included in the header. As described in greater detail below, the version of the file may be the original file or a different version of the original file.

The first block 6781 in the blockchain is referred to as the genesis block and includes the header 6721, original file 6741, and an initial value 6761. The hashing scheme used for the genesis block, and indeed in all subsequent blocks, may vary. For example, all the information in the first block 6781 may be hashed together and at one time, or each or a portion of the information in the first block 6781 may be separately hashed and then a hash of the separately hashed portions may be performed.

The header 6721 may include one or more initial parameters, which, for example, may include a version number, timestamp, nonce, root information, difficulty level, consensus protocol, duration, media format, source, descriptive keywords, and/or other information associated with original file 6741 and/or the blockchain. The header 6721 may be generated automatically (e.g., by blockchain network managing software) or manually by a blockchain participant. Unlike the header in other blocks 6782 to 678N in the blockchain, the header 6721 in the genesis block does not reference a previous block, simply because there is no previous block.

The original file 6741 in the genesis block may be, for example, data as captured by a device with or without processing prior to its inclusion in the blockchain. The original file 6741 is received through the interface of the system from the device, media source, or node. The original file 6741 is associated with metadata, which, for example, may be generated by a user, the device, and/or the system processor, either manually or automatically. The metadata may be included in the first block 6781 in association with the original file 6741.

The value 6761 in the genesis block is an initial value generated based on one or more unique attributes of the original file 6741. In some embodiments, the one or more unique attributes may include the hash value for the original file 6741, metadata for the original file 6741, and other information associated with the file. In one implementation, the initial value 6761 may be based on the following unique attributes:

1) SHA-2 computed hash value for the original file

2) originating device ID

3) starting timestamp for the original file

4) initial storage location of the original file

5) blockchain network member ID for software to currently control the original file and associated metadata

The other blocks 6782 to 678N in the blockchain also have headers, files, and values. However, unlike header 6721 the first block, each of the headers 6722 to 672N in the other blocks includes the hash value of an immediately preceding block. The hash value of the immediately preceding block may be just the hash of the header of the previous block or may be the hash value of the entire previous block. By including the hash value of a preceding block in each of the remaining blocks, a trace can be performed from the Nth block back to the genesis block (and the associated original file) on a block-by-block basis, as indicated by arrows 680, to establish an auditable and immutable chain-of-custody.

Each of the header 6722 to 672N in the other blocks may also include other information, e.g., version number, timestamp, nonce, root information, difficulty level, consensus protocol, and/or other parameters or information associated with the corresponding files and/or the blockchain in general.

The files 6742 to 674N in the other blocks may be equal to the original file or may be a modified version of the original file in the genesis block depending, for example, on the type of processing performed. The type of processing performed may vary from block to block. The processing may involve, for example, any modification of a file in a preceding block, such as redacting information or otherwise changing the content of, taking information away from, or adding or appending information to the files.

Additionally, or alternatively, the processing may involve merely copying the file from a preceding block, changing a storage location of the file, analyzing the file from one or more preceding blocks, moving the file from one storage or memory location to another, or performing action relative to the file of the blockchain and/or its associated metadata. Processing which involves analyzing a file may include, for example, appending, including, or otherwise associating various analytics, statistics, or other information associated with the file.

The values in each of the other blocks 6762 to 676N in the other blocks are unique values and are all different as a result of the processing performed. For example, the value in any one block corresponds to an updated version of the value in the previous block. The update is reflected in the hash of the block to which the value is assigned. The values of the blocks therefore provide an indication of what processing was performed in the blocks and also permit a tracing through the blockchain back to the original file. This tracking confirms the chain-of-custody of the file throughout the entire blockchain.

For example, consider the case where portions of the file in a previous block are redacted, blocked out, or pixelated in order to protect the identity of a person shown in the file. In this case, the block including the redacted file may include metadata associated with the redacted file, e.g., how the redaction was performed, who performed the redaction, timestamps where the redaction(s) occurred, etc. The metadata may be hashed to form the value. Because the metadata for the block is different from the information that was hashed to form the value in the previous block, the values are different from one another and may be recovered when decrypted.

In some embodiments, the value of a previous block may be updated (e.g., a new hash value computed) to form the value of a current block when any one or more of the following occurs. The new hash value may be computed by hashing all or a portion of the information noted below, in this example embodiment.

a) new SHA-2 computed hash value if the file has been processed in any way (e.g., if the file was redacted, copied, altered, accessed, or some other action was taken)

b) new storage location for the file

c) new metadata identified associated with the file

d) transfer of access or control of the file from one blockchain participant to another blockchain participant

FIG. 6D illustrates an embodiment of a block which may represent the structure of the blocks in the blockchain 690 in accordance with one embodiment. The block, Blocki, includes a header 672i, a file 674i, and a value 676i.

The header 672i includes a hash value of a previous block Blocki-1 and additional reference information, which, for example, may be any of the types of information (e.g., header information including references, characteristics, parameters, etc.) discussed herein. All blocks reference the hash of a previous block except, of course, the genesis block. The hash value of the previous block may be just a hash of the header in the previous block or a hash of all or a portion of the information in the previous block, including the file and metadata.

The file 674i includes a plurality of data, such as Data 1, Data 2, . . . , Data N in sequence. The data are tagged with Metadata 1, Metadata 2, . . . , Metadata N which describe the content and/or characteristics associated with the data. For example, the metadata for each data may include information to indicate a timestamp for the data, process the data, keywords indicating the persons or other content depicted in the data, and/or other features that may be helpful to establish the validity and content of the file as a whole, and particularly its use a digital evidence, for example, as described in connection with an embodiment discussed below. In addition to the metadata, each data may be tagged with reference REF1, REF2, . . . , REFN to a previous data to prevent tampering, gaps in the file, and sequential reference through the file.

Once the metadata is assigned to the data (e.g., through a smart contract), the metadata cannot be altered without the hash changing, which can easily be identified for invalidation. The metadata, thus, creates a data log of information that may be accessed for use by participants in the blockchain.

The value 676i is a hash value or other value computed based on any of the types of information previously discussed. For example, for any given block Blocki, the value for that block may be updated to reflect the processing that was performed for that block, e.g., new hash value, new storage location, new metadata for the associated file, transfer of control or access, identifier, or other action or information to be added. Although the value in each block is shown to be separate from the metadata for the data of the file and header, the value may be based, in part or whole, on this metadata in another embodiment.

Once the blockchain 670 is formed, at any point in time, the immutable chain-of-custody for the file may be obtained by querying the blockchain for the transaction history of the values across the blocks. This query, or tracking procedure, may begin with decrypting the value of the block that is most currently included (e.g., the last (Nth) block), and then continuing to decrypt the value of the other blocks until the genesis block is reached and the original file is recovered. The decryption may involve decrypting the headers and files and associated metadata at each block, as well.

Decryption is performed based on the type of encryption that took place in each block. This may involve the use of private keys, public keys, or a public key-private key pair. For example, when asymmetric encryption is used, blockchain participants or a processor in the network may generate a public key and private key pair using a predetermined algorithm. The public key and private key are associated with each other through some mathematical relationship. The public key may be distributed publicly to serve as an address to receive messages from other users, e.g., an IP address or home address. The private key is kept secret and used to digitally sign messages sent to other blockchain participants. The signature is included in the message so that the recipient can verify using the public key of the sender. This way, the recipient can be sure that only the sender may have sent this message.

Generating a key pair may be analogous to creating an account on the blockchain, but without having to actually register anywhere. Also, every transaction that is executed on the blockchain is digitally signed by the sender using their private key. This signature ensures that only the owner of the account can track and process (if within the scope of permission determined by a smart contract) the file of the blockchain.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

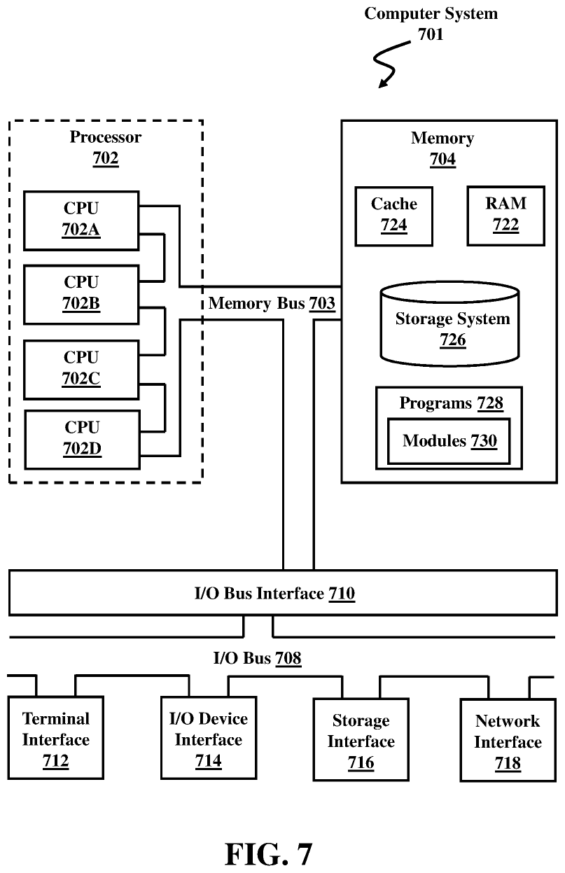

FIG. 7, illustrated is a high-level block diagram of an example computer system 701 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 701 may comprise one or more CPUs 702, a memory subsystem 704, a terminal interface 712, a storage interface 716, an I/O (Input/Output) device interface 714, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable central processing units (CPUs) 702A, 702B, 702C, and 702D, herein generically referred to as the CPU 702. In some embodiments, the computer system 701 may contain multiple processors typical of a relatively large system; however, in other embodiments the computer system 701 may alternatively be a single CPU system. Each CPU 702 may execute instructions stored in the memory subsystem 704 and may include one or more levels of on-board cache.

System memory 704 may include computer system readable media in the form of volatile memory, such as random access memory (RAM) 722 or cache memory 724. Computer system 701 may further include other removable/non-removable, volatile/non-volatile computer system storage media. By way of example only, storage system 726 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 704 can include flash memory, e.g., a flash memory stick drive or a flash drive. Memory devices can be connected to memory bus 703 by one or more data media interfaces. The memory 704 may include at least one program product having a set (e.g., at least one) of program modules that are configured to carry out the functions of various embodiments.

One or more programs/utilities 728, each having at least one set of program modules 730 may be stored in memory 704. The programs/utilities 728 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 728 and/or program modules 730 generally perform the functions or methodologies of various embodiments.

Although the memory bus 703 is shown in FIG. 7 as a single bus structure providing a direct communication path among the CPUs 702, the memory subsystem 704, and the I/O bus interface 710, the memory bus 703 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units are shown, which separate the I/O bus 708 from various communications paths running to the various I/O devices, in other embodiments some or all of the I/O devices may be connected directly to one or more system I/O buses.

In some embodiments, the computer system 701 may be a multi-user mainframe computer system, a single-user system, or a server computer or similar device that has little or no direct user interface, but receives requests from other computer systems (clients). Further, in some embodiments, the computer system 701 may be implemented as a desktop computer, portable computer, laptop or notebook computer, tablet computer, pocket computer, telephone, smartphone, network switches or routers, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

1. A method comprising:
receiving, by a path object builder node, a digital asset transfer request for a digital asset transfer;
creating, by the path object builder node, a path object containing one or more legal jurisdictional requirements for the digital asset transfer request
wherein the path object contains due diligence performed to comply with legal jurisdictional requirements;
passing, by the path object builder node, the path object to a blockchain network;
verifying, by one or more nodes in the blockchain network, the path object; and
recording the path object on a blockchain network.

2. The method of claim 1, wherein the creating further comprises:
determining, by the path object builder node, party requirements for the digital asset transfer,
wherein, the party requirements include one or more requirements for a digital asset transferor and one or more requirements for a digital asset recipient.

3. The method of claim 2 further comprising:
performing, by the path object builder, a conflict check based on the one or more legal jurisdictional requirements, and the one or more requirements for the digital asset transferor, and the one or more requirements for the digital asset recipient.

4. The method of claim 3 further comprising:
determining, by the path object builder based on the performing, that there is a conflict;
sending, by the path object builder based on the determining, a notification to one or more parties requesting instructions on how to process the digital asset with regard to the conflict;
receiving, by the path object builder, the instructions; and
implementing, by the path object builder, the instructions in the creation of the path object.

5. The method of claim 1, wherein the creating further comprises:
referencing, by the path object builder node, a smart compliance routing system to determine a route; and
determining, by the smart compliance routing system, what jurisdictions would have influence or control over the completion of the digital asset transfer.

6. The method of claim 5, wherein the creating further comprises:
referencing, by the path object builder node, a jurisdictional smart contract registry to determine the one or more legal jurisdictional requirements on the digital asset transfer for the jurisdictions that would have influence or control over the completion of the digital asset transfer.

7. The method of claim 1, wherein the verifying further comprises:
verifying, by one or more nodes in the blockchain network, that the path object includes necessary jurisdictions and comports with jurisdictional requirements.

8. A system comprising:
a memory; and
a processor in communication with the memory, the processor being configured to perform operations comprising:
receiving a digital asset transfer request for a digital asset transfer;
creating a path object containing one or more legal jurisdictional requirements for the digital asset transfer request,
wherein the path object contains due diligence performed to comply with legal jurisdictional requirements;
passing the path object to a blockchain network;
verifying the path object; and
recording the path object on a blockchain network.

9. The system of claim 8, wherein the creating further comprises:
determining the party requirements for the digital asset transfer,
wherein, the party requirements include one or more requirements for the digital asset transferor and one or more requirements for the digital asset recipient.

10. The system of claim 9 further comprising:
performing a conflict check based on the one or more legal jurisdictional requirements, and the one or more requirements for the digital asset transferor, and the one or more requirements for the digital asset recipient.

11. The system of claim 10 further comprising:
determining, based on the performing, that there is a conflict;
sending, based on the determining, a notification to one or more parties requesting instructions on how to process the digital asset with regard to the conflict;
receiving the instructions; and
implementing the instructions in the creation of the path object.

12. The system of claim 8, wherein the creating further comprises:
referencing a smart compliance routing system to determine a route; and
determining, by the smart compliance routing system, what jurisdictions would have influence or control over the completion of the digital asset transfer.

13. The system of claim 12, wherein the creating further comprises:
referencing a jurisdictional smart contract registry to determine the one or more legal jurisdictional requirements on the digital asset transfer for the jurisdictions that would have influence or control over the completion of the digital asset transfer.

14. The system of claim 13, wherein the verifying further comprises:
verifying, by one or more nodes in the blockchain network, that the path object includes necessary jurisdictions and has comported with jurisdictional requirements.

15. A computer program product comprising a computer readable storage medium having program instructions embodied therewith, the program instructions executable by a processor to cause the processors to perform a function, the function comprising:
receive a digital asset transfer request for a digital asset transfer;
create a path object containing one or more legal jurisdictional requirements for the digital asset transfer request,
wherein the path object contains due diligence performed to comply with legal jurisdictional requirements;
pass the path object to a blockchain network;
verify, by one or more nodes in the blockchain network, the path object; and
record the path object on a blockchain network.

16. The computer program product of claim 15 further comprising:
determining the party requirements for the digital asset transfer,
wherein, the party requirements include one or more requirements for the digital asset transferor and one or more requirements for the digital asset recipient.

17. The computer program product of claim 15 further comprising:
performing a conflict check based on the one or more legal jurisdictional requirements, and the one or more requirements for the digital asset transferor, and the one or more requirements for the digital asset recipient.

18. The computer program product of claim 17 further comprising:
determining, based on the performing, that there is a conflict;
sending, based on the determining, a notification to one or more parties requesting instructions on how to process the digital asset with regard to the conflict;
receiving the instructions; and
implementing the instructions in the creation of the path object.

19. The computer program product of claim 15, wherein the creating further comprises:
referencing a smart compliance routing system to determine a route; and
determining, by the smart compliance routing system, what jurisdictions would have influence or control over the completion of the digital asset transfer.

20. The computer program product of claim 19, wherein the creating further comprises:
referencing a jurisdictional smart contract registry to determine the one or more legal jurisdictional requirements on the digital asset transfer for the jurisdictions that would have influence or control over the completion of the digital asset transfer.
